(19) United States
(12) Patent Application Publication
(10) Pub. No.: US 2025/0013479 A1
(43) Pub. Date: Jan. 9, 2025

(54) METHOD, APPARATUS, DEVICE AND STORAGE MEDIUM FOR PROCESSING INFORMATION

(71) Applicants: Beijing Zitiao Network Technology Co., Ltd., Beijing (CN); Lemon Inc., Grand Cayman (KY)

(72) Inventors: Junli XIAN, Beijing (CN); Bowen SHEN, Beijing (CN); Xin XIE, Singapore (SG)

(21) Appl. No.: 18/891,729

(22) Filed: Sep. 20, 2024

(30) Foreign Application Priority Data
Sep. 28, 2023 (CN) 202311282118.3

(51) Int. Cl. G06F 9/451; G06F 3/0482; G06F 3/0484

(52) U.S. Cl. CPC G06F 9/453; G06F 3/0482; G06F 3/0484

(57) ABSTRACT

According to embodiments of the disclosure, a method, an apparatus, a device and a storage medium for processing information are provided. In the method, first information input by a target object to a digital assistant is obtained; and second information is generated as a response of the digital assistant to the first information based at least on the first information and historical interaction information between the target object and at least one service component. Thus, by generating a response of the digital assistant based on the historical interaction information between the target object and the service component, the embodiments of the disclosure can improve the quality of the response content generated by the digital assistant.

### CROSS REFERENCE

This application claims priority of the Chinese patent application No. 2023112821183, filed on Sep. 28, 2023 and entitled “METHOD, APPARATUS, DEVICE AND STORAGE MEDIUM FOR PROCESSING INFORMATION”, the entire content of which is incorporated herein by reference.

### FIELD

Example embodiments of the present disclosure generally relate to the field of computers, and in particular, to method, apparatus, device and computer-readable storage medium for processing information.

### BACKGROUND

With the rapid development of Internet technologies, the Internet has become an important platform for people to obtain and share content, and users can access the Internet through terminal devices to enjoy various Internet services.

In addition, the Internet platform can also provide users with capabilities related to various types of information processing. How to improve the accuracy of such information processing has become people's focus of attention.

### SUMMARY

In a first aspect of the present disclosure, a method of processing information is provided. The method comprises: obtaining first information input by a target object to a digital assistant; and generating second information as a reply of the digital assistant to the first information based at least on the first information and historical interaction information between the target object and at least one service component.

In a second aspect of the present disclosure, a method of processing information is provided. The method comprises: determining a set of historical interaction information between a target object and at least one service component; obtaining configuration information indicating a part of the set of historical interaction information that is not provided to a digital assistant for interaction with the target object; and determining, based on the configuration information, target historical interaction information from the set of historical interaction information for use by the digital assistant in generating a response to first information input to the digital assistant by the target object.

In a third aspect of the present disclosure, an apparatus for processing information is provided. The device comprises: a first obtaining module, configured to obtain first information input by a target object to a digital assistant; and an information generation module, configured to generate second information as a response of the digital assistant to the first information based at least on the first information and historical interaction information between the target object and at least one service component.

In a fourth aspect of the present disclosure, an apparatus for processing information is provided. The apparatus comprises: a history determination module, configured to determine a set of historical interaction information between a target object and at least one service component; a second obtaining module, configured to obtain configuration information indicating a part of the set of historical interaction information is not provided to a digital assistant for interaction with the target object; and an information determination module, configured to determine, based on the configuration information, target historical interaction information from the set of historical interaction information for use by the digital assistant in generating a response to first information input to the digital assistant by the target object.

In a fifth aspect of the present disclosure, an electronic device is provided. The device comprises at least one processing unit; and at least one memory coupled to the at least one processing unit and storing instructions for execution by the at least one processing unit. The instructions, when executed by the at least one processing unit, cause the device to perform the method of the first aspect.

In a sixth aspect of the present disclosure, a computer-readable storage medium is provided. The computer-readable storage medium stores a computer program, and the computer program is executable by the processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRA WINGS

The above and other features, advantages, and aspects of various embodiments of the present disclosure will become more apparent from the following detailed description taken in connection with the accompanying drawings. In the drawings, the same or similar reference numbers refer to the same or similar elements, wherein:

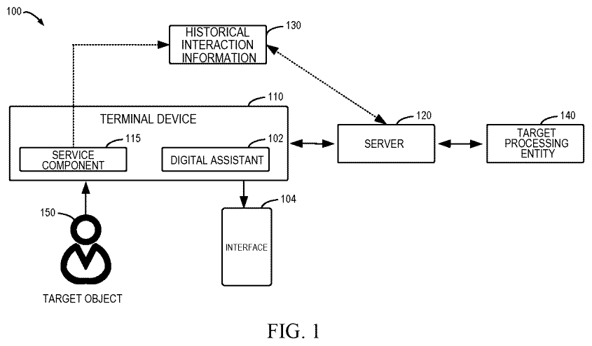

FIG. 1 illustrates a schematic diagram of an example environment in which embodiments of the present disclosure can be implemented;

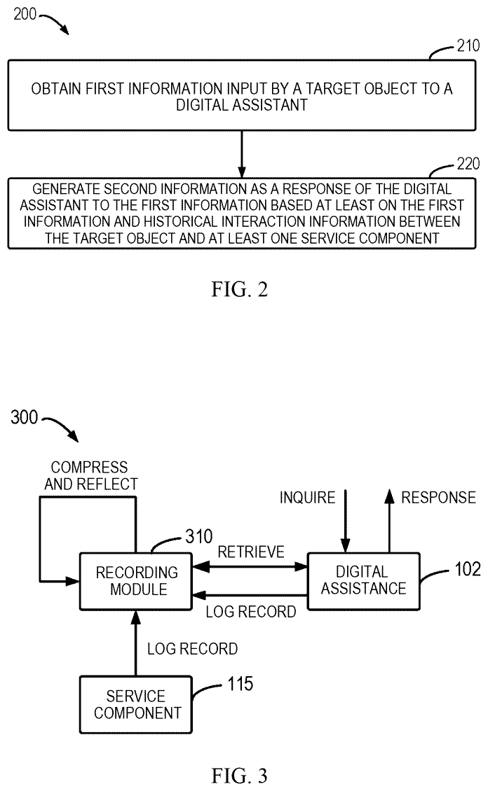

FIG. 2 illustrates a flowchart of a method for processing information according to some embodiments of the present disclosure;

FIG. 3 illustrates an example system architecture according to some embodiments of the present disclosure;

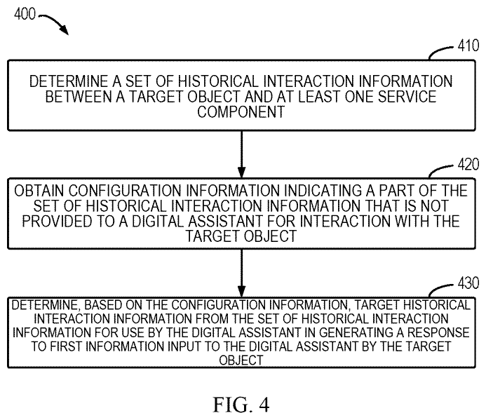

FIG. 4 illustrates a flowchart of a method for processing information according to yet some embodiments of the present disclosure;

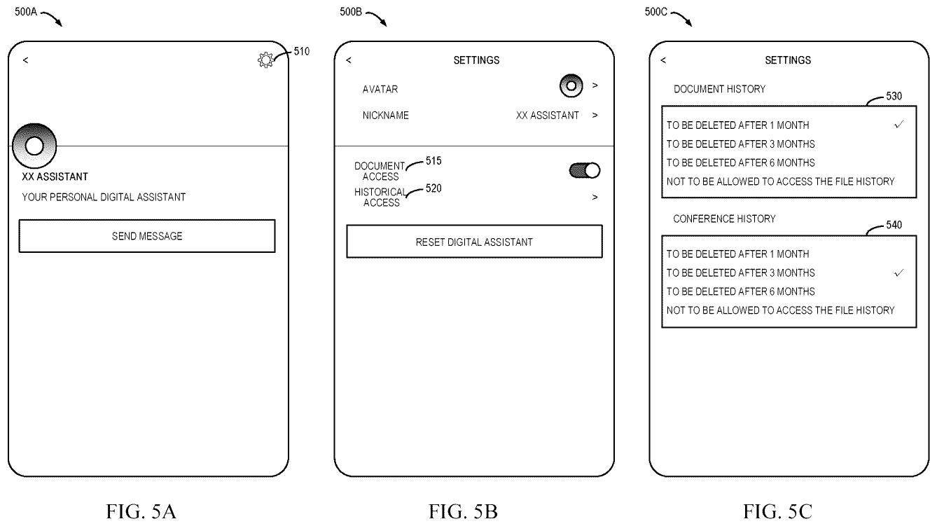

FIG. 5A to FIG. 5C illustrate schematic diagrams of example interfaces of a digital assistant according to some embodiments of the present disclosure;

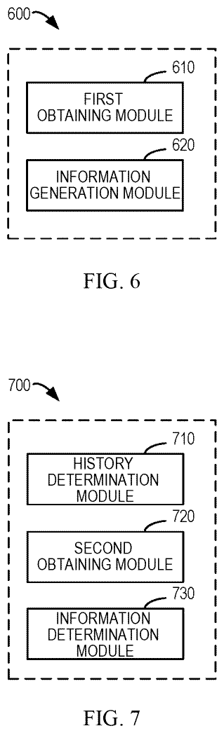

FIG. 6 illustrates a block diagram of an apparatus for processing information according to some embodiments of the present disclosure;

FIG. 7 illustrates a block diagram of an apparatus for processing information according to some embodiments of the present disclosure; and

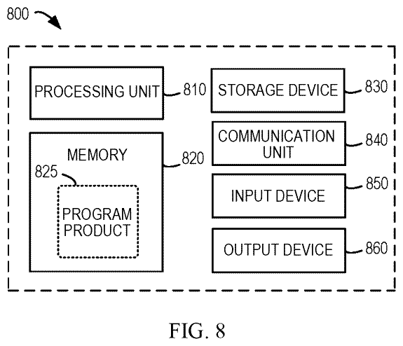

FIG. 8 illustrates a block diagram of a device capable of implementing various embodiments of the present disclosure.

### DETAILED DESCRIPTION

It is to be understood that, before the technical solutions disclosed in the embodiments of the present disclosure are used, the related users should be informed of the type, range of application, the usage scenario, and the like of the information related to the present disclosure in an appropriate manner in accordance with relevant laws and regulations and the authorization of the related users should be obtained. The related users may include any type of right subjects, such as individuals, enterprises, organizations.

For example, in response to receiving an active request from a user, prompt information is sent to the relevant user to explicitly prompt the relevant user that the operation requested by the user to be performed will need to obtain and use the information of the relevant user. Therefore, the related user can autonomously select whether to provide information to software or hardware such as electronic device, application, server or storage medium and etc., executing the operation of the technical solution of the present disclosure according to the prompt information.

As an optional but non-limiting implementation, in response to receiving an active request of a related user, a manner of sending prompt information to the related user may be, for example, a pop-up window, and prompt information may be presented in a text manner in the pop-up window. In addition, the pop-up window may further carry a selection control for the user to select “agree” or “not agree” to provide information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

It is to be understood that, when the technical solution is used, the data involved (including but not limited to the data itself, the data acquisition, use, storage, and transmission) should follow the requirements of the corresponding laws and regulations and related regulations.

The term “in response to” as used herein means a state in which a respective event occurs, or condition is satisfied. It will be appreciated that the timing of execution of a subsequent action performed in response to the event or condition is not necessarily strongly correlated with the time at which the event occurs, or the condition holds. For example, in some cases, subsequent actions may be performed immediately when an event occurs or a condition holds; while in other cases, subsequent actions may be performed after a period of time elapses after an event occurs or a condition holds.

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the headline of any section/subsection provided herein is not limiting. Various embodiments are described throughout, and any type of embodiments may be included in any section/subsection. Furthermore, the embodiments described in any section/subsection may be combined in any manner with any other embodiment described in the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definition may also be included below. The terms “first,” “second,” and the like may refer to different or identical object. Other explicit and implicit definition may also be included below.

As used herein, the term “model” may learn associations between respective inputs and outputs from training data such that corresponding outputs may be generated for a given input after training is complete. The generation and use of the model may be based on the technology allowed by laws and regulations such as machine learning and the like, which may be referred to as usable technologies for short. As an example, deep learning is a machine learning algorithm that processes inputs and provides corresponding outputs by using a multi-layer processing unit. “Model” may also be referred to herein as a “machine learning model.” “machine learning network,” or “network,” which terms are used interchangeably herein. A model may in turn include different types of processing units or networks.

As briefly mentioned above, various types of information processing tools have been utilized to improve the efficiency of information processing. For example, some digital assistants can generate respective responses based on dialog interactions with the user (e.g., text or speech).

However, such information processing procedures are often a generalization capability that faces numerous users to provide similar information processing capabilities. However, in the case that the interaction habits and requirements of different user are different, it may be difficult for the user to obtain the desired information processing result.

According to a first aspect of the present disclosure, an embodiment of the present disclosure provides a solution for processing information. Specifically, the first information input by the target object (for example, a user or an organization) to the digital assistant may be obtained. Further, the second information may be generated as a response of the digital assistant to the first information based at least on the first information and historical interaction information between the target object and at least one service component.

Thus, by generating a response of the digital assistant based on the historical interaction information of the target object and the service component, embodiments of the present disclosure can improve the quality of the response content generated by the digital assistant.

According to a second aspect of the present disclosure, an embodiment of the present disclosure provides a solution for processing information. Specifically, a set of historical interaction information between a target object (for example, a user or an organization) and at least one service component may be determined. Further, configuration information may be obtained, wherein the configuration information indicates a part of the set of historical interaction information that is not provided to a digital assistant for interaction with the target object. Accordingly, the target historical interaction information may be determined, based on the configuration information, from the set of historical interaction information for use by the digital assistant in generating a response to first information input to the digital assistant by the target object.

Therefore, the embodiment of the invention can support the user to configure the range of the historical interaction information on which the digital assistant is based in generating the response, so that the response generated by the digital assistant is more consistent with the expectation of the user.

Example embodiments of the present disclosure are described below with reference to the accompanying drawings.

### Example Environment

FIG. 1 illustrates a schematic diagram of an example environment 100 in which embodiments of the present disclosure can be implemented. As shown in FIG. 1, in environment 100, terminal device 110 may be utilized to provide digital assistant 102 for target object 150. Such target objects may include users or organizations, etc., where the organization may be an enterprise, group, department, or the like.

For example, such a digital assistant 102 may also be referred to as a digital assistant, or a digital robot. It should be understood that while the digital assistant 102 is shown included in the terminal device 110 in FIG. 1, the part of the processing capability of the digital assistant 102 may also be based at least in part on the server 120, for example. For example, a front end portion (e.g., a portion for presentation) of the digital assistant 102 may be included in the terminal device 110, but a back end portion (e.g., a portion for processing information) of the digital assistant 102 may be included in the server 120.

In some examples, the digital assistant 102 may be, for example, a digital assistant that assists the target object 150 in, for example, office, or may be in any other suitable form of entity. The digital assistant 102 may also operate independently or be integrated into a particular application.

In some embodiments, the digital assistant 102 may be enabled, such as, invoked or awakened in an appropriate manner (e.g., a shortcut key, button, or voice). If the digital assistant 102 is active, the terminal device 110 may present the interface 104 associated with the digital assistant 102. The interface 104 may be in a style of a conversational user interface (also referred to as a session interface or a session window), or may be any other suitable form of interface. As will be described in detail below, such an interface 104 may also include interface elements for information interaction, such as message input boxes, message lists, message bubbles, and the like. Through the interface 104, the digital assistant 102 may obtain information (also referred to as first information) input by the target object 150.

Such input information may include, for example, any suitable type of message, such as a text message, a picture message, a voice message, a table message, a link message, other suitable types of messages, and the like.

Further, the server 120 may allow the target object 150 to interact with the digital assistant 102 to obtain information generated by the digital assistant 102. Alternatively, in a scenario where the authorization of the target object 150 is obtained, the information generated by the digital assistant 102 may also be based on the historical interaction between the target object 150 and the at least one service component 115, as will be described in detail below.

Such service components may include components capable of providing appropriate types of business services for the target object 150, examples of which may include, but are not limited to, office type components, tool type components, and the like. In some embodiments, such service components may be installed on a same terminal device 110, for example, various types of service components are integrated in a same platform type application to be installed on a same terminal device. Alternatively, or additionally, such service component may also be installed on other terminal devices, or provided in a cloud service manner. It should be understood that, although the service component 115 is shown as being included in the terminal device 110 in FIG. 1, the part of the processing capability of the service component 115 may be based at least in part on the server of the service component itself, and the server of the service component itself may be the server 120 in FIG. 1, or may be another server, which is not limited in the middle of the present disclosure.

In some embodiments, such service components 115 may include a plurality of office components in an office suite. The office suite may be a suite of office components developed to improve collaborative office efficiency, such as office components for creating and editing documents, office components for creating and editing tables, office components for drawing, office components for communication and chatting, office components for holding audio and video conferences, office components for users to formulate tasks or schedule, and the like.

In some embodiments, the plurality of office components includes a plurality of the following: a chat component, a document component, an audio and video conference component, a mail component, a calendar component, a schedule component, a task component, an objectives and key results (OKR) component, and/or an appropriate office component currently available or possibly developed in the future.

In some embodiments, the digital assistant 102 may be a separate application different from the service component 115. Alternatively, the digital assistant 102 may also be a function or component suitably integrated into the service component 115.

In some embodiments, the historical interaction information 130 may be maintained at appropriate electronic devices as needed, such as the terminal device 110, the server 120, and/or other suitable electronic devices. The historical interaction information 130 may include, for example, interaction information stored on the terminal device 110 and interaction information that has been uploaded to the server 120.

As an example, the digital assistant 102 may obtain input information of the target object 150, and the digital assistant 102 or the server 120 may generate corresponding information (also referred to as third information) based on the input information and the historical interaction information 130. The historical interaction information 130 may, for example, indicate a historical interaction process and/or result between the target object 150 and the at least one service component 115.

Further, the server 120 or the digital assistant 102 may send the generated third information to the target processing entity 140. Further, the server 120 or the digital assistant 102 may generate corresponding information (also referred to as second information) based on the information returned by the target processing entity 140 (that is, the processing result for the third information). Such second information may, for example, be presented to the target object 150 via an interface 104 corresponding to the digital assistant 102.

The target processing entity 140 may be a processing entity based on a suitable information processing technology, and may implement one or more functions of text generation, image generation, summarization, encoding, translation, chatting, task disassembly, and the like. The target processing entity 140 may also be any other suitable entity form.

In some embodiments, terminal device 110 communicates with server 120 to enable provision of services to digital assistant 102. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 can also support any type of interface (such as a “wearable” circuit, etc.) for the target object 150. The server 120 may be various types of computing systems/servers capable of providing computing power, including, but not limited to, mainframes, edge computing nodes, computing devices in a cloud environment, and the like.

Although only one server 120 is shown in FIG. 1, the environment 100 may include a plurality of servers 120. For example, the historical interaction information 130 may be stored locally or in the second server 120 as needed as well as authorized by related user, and the target processing entity 140 runs on the third server 120. It should be understood that the description herein is merely exemplary and does not imply any limitation on the scope of the present disclosure.

It should be understood that the structure and function of the environment 100 is described for exemplary purposes only and does not imply any limitation to the scope of the present disclosure.

Some example embodiments of the present disclosure will be described below with continued reference to the accompanying drawings.

### First Example Information Processing Procedure

FIG. 2 illustrates a flowchart of a process 200 for processing information according to some embodiments of the present disclosure. The process 200 may be implemented by a suitable electronic device or a combination of electronic devices (e.g., server 120, terminal device 110, or a combination of server 120 and terminal device 110 in FIG. 1). For ease of description, the process 200 is described below by using the server 120 as an example and with reference to FIG. 1.

At block 210, the server 120 obtains first information input by a target object 150 to a digital assistant 102.

In some embodiments, the target object 150 includes a user and/or an organization, for example, a user, a project group, a research group, a department, and the like. For example, such a target object 150 may be configured as a corresponding digital assistant 102. In some embodiments, the target object 150 is identified by a corresponding one or more accounts.

In some embodiments, the digital assistant 102 may be provided, for example, as a digital assistant corresponding to the target object 150. As an example, such a digital assistant may be created as a contact specific to the target object 150. In some embodiments, the contact specific to the target object 150 includes a one-to-one correspondence between the digital assistant and the target object. In some embodiments, the digital assistant is only visible to the target object 150 and is not visible to other target object.

In yet another example, the target object 150 includes an aggregated object (e.g., an organization, a team, etc.) comprising a plurality of users, and the plurality of users may each be, for example, provided to correspond to a single digital assistant 102 corresponding to the aggregated object. In another example, a plurality of users in the aggregated object may, for example, not only be provided with a digital assistant 102 corresponding to the aggregated object, but also provided with another digital assistant 102 that corresponds to each of the respective users.

Further, the target object 150 may input the first information to the digital assistant 102 in an appropriate manner. Such first information may include, for example, text messages, voice messages, image messages, or other suitable types of information. In some scenarios, the first information may also be referred to as a query message.

In some embodiments, the target object 150 may, for example, implement interaction with the digital assistant 102 through a graphical interface. The present disclosure is not intended to limit the specific way the target object 150 inputs the first information.

With continued reference to FIG. 2, at block 220, the server 120 generates second information as a response of the digital assistant 102 to the first information based at least on the first information and historical interaction information between the target object 150 and at least one service component 115.

The generation and management process of the historical interaction information 130 will be described below with reference to FIG. 3, which shows an example system architecture 300 according to an embodiment of the present disclosure.

As shown in FIG. 3, when the target object 150 interacts with the service component 115, the service component 115 may generate a log record, and send the log record to the recording module 310.

Further, the recording module 310 may generate a corresponding record entry based on the received log record, and construct a record library. In some embodiments, such record entries may include knowledge elements for describing service object corresponding to historical interaction event. In some embodiments, the record library may be maintained at an appropriate electronic device, which may be stored at the terminal device 110, for example, or stored at the server 120.

In some embodiments, such service object may include service object, edited service object, referenced service object, shared service object, and the like generated during the interaction between the target object 150 and the service component 115. Taking the service component 115 as a document component as an example, the historical interaction event may include a creation event of a specific document in the document component by the target object 150, and accordingly, the service object corresponding to the document creation event may include the specific document. For another example, taking the service component 115 as an audio and video conference component as an example, the historical interaction event may include an audio-video conference event in which the target object 150 participates, and accordingly, the service object corresponding to the audio-video conference event may include the audio-video conference itself.

In some embodiments, the knowledge element may be a natural language description about the service object, which is intended to abstract and/or compress the content of the service object. For example, the document object is used as an example of a service object, and the knowledge element may be used to describe a topic, a completion status, an audience, a language, an expression style, and the like of the document object. Taking the audio and video conference as an example of a service object, the knowledge element may be used to describe a topic, an agenda, an abstract of the conference content, and the like of the audio-video conference.

It should be understood that information of different dimensions may be selected based on difference types of service objects to generate a knowledge element for describing the service object. For example, taking a session as an example of a service object, a knowledge element may be used, for example, to describe a type (e.g., whether it is a single chat), a summary of session content, or the like of the session.

Thus, by maintaining a knowledge element in a record entry, embodiments of the present disclosure may describe or characterize a service object involved in a corresponding historical interaction event through a limited content length.

In some embodiments, the record entry may further include a time element for indicating an occurrence time of the historical interaction event. For example, continuing to take creating a document as an example of a historical interaction event, such a time element may, for example, indicate a creation time of the document.

In still other embodiments, the record entry may also include an action element for indicating an event type of the historical interaction event. Continuing to take creating a document as an example of a historical interaction event, such action elements may, for example, indicate that the type of the historical interaction event is a “create document” type.

It should be understood that the type of the event may be appropriately divided according to the scenario needs. Taking a document as an example of a service object, the corresponding type may include, for example, a production event (for example, creation) of the document, a consumption event (for example, browsing) of the document, a circulation event (for example, sharing) of the document, and a management event (for example, a permission setting) of the document.

In some embodiments, the record entry may also include load elements for indexing service object corresponding to respective historical interaction event. Taking a document as an example of a service object, the load element may include, for example, a document number or a document identifier used to index the document.

Thus, in some scenarios, after the target object 150 interacts with the service component 115, the recording module 310 may generate a corresponding record entry. Such a record entry may be represented, for example, as {time element, action element, knowledge element, load element}, to describe the historical interaction event from a plurality of predetermined dimensions.

It should be understood that the record entry may also include other suitable elements for describing other suitable dimensions of the corresponding historical interaction event.

Based on such a manner, the recording module 310 may support interaction between the target object 150 and the digital assistant 102 by maintaining a set of record entries in the record library. Such a record library may also be similar to the “memory information” of the digital assistant, helping the digital assistant to increase the quality of the generated response content. Such a record library may also be referred to as a set of historical interaction information.

In some embodiments, considering that there are more and more interactions between the target object 150 and the service component 115, the size of the corresponding record library will be larger and larger. To manage the historical interaction information more effectively, the recording module 310 may also perform compression processing on the record entries.

For example, the recording module 310 may, for example, periodically compress the record entries in the record library to compress the plurality of record entries into one record compression entry. For example, the recording module 310 may perform compression processing of the record entry according to the occurrence time of the historical interaction event.

In some embodiments, when the plurality of historical interaction events have occurred to satisfy the predetermined condition, the recording module 310 may remove the record entry of the plurality of historical machine interaction event from the record library, and generate a corresponding record compression entry. As an example, the predetermined condition may include that a plurality of historical interaction events have occurred longer than a threshold duration (for example, one month). Alternatively, the predetermined condition may further include removing and compressing the historical interaction event according to a predetermined period.

For example, the recording module 310 may identify a set of record entries to be compressed from a record library, such set of record entries to be compressed may correspond to, for example, an associated interaction event (for example, associated with a same service object) whose occurrence date has exceeded a threshold duration.

For example, the target object 150 may create, edit, and share a document A within a week, a month ago. Accordingly, three record entries corresponding to these three historical interaction events may be previously maintained in the record library. Further, the recording module 310 may compress the three record entries into a single record compression entry upon determining that the three historical interaction events occurred one month ago.

In the process of compressing the plurality of record entries into a single record compression entry, the record module 310 may, for example, retain only important information in the plurality of record entries, thereby reducing the storage and management consumption of the record entries. The important information herein may be determined according to a predetermined policy.

In some embodiments, the manner of compressing the record entry may further include, for example, retaining a part of record entries in the record entry to be compressed. Continuing to take the example of creating, editing, and sharing the document A, the recording module 310 may, for example, only retain a record entry corresponding to the “Edit document A”, which may also be referred to as a record compression entry.

Such a recording manner can also be similar to a management manner of human memory, that is, for a historical event with an earlier time, the recording module may maintain relatively fuzzy record information, and conversely, for a historical event with a closer time, the recording module may maintain more accurate record information.

In some embodiments, the recording module 310 may, for example, utilize a compression model to achieve compression for the recording entries. Specifically, the recording module 310 may, for example, provide the plurality of record entries to be compressed to the record model to obtain record compression entries corresponding to the plurality of record entries to be compressed. Such a compression model may be implemented with an appropriate machine learning model.

In some examples, the compression model may be the target processing entity 140 discussed with reference to FIG. 1. That is, the recording module 310 may obtain a compressed record compression entry by providing the target processing entity 140 with a prompt and a plurality of record entries to be compressed for instructing the target processing entity 140 to perform the compression. For example, such a prompt may be “Please select the most representative three record entries from a plurality of record entries below” or “Please compress the following plurality of record entries into a single entry”.

In this way, the recording module 310 may, for example, periodically compress the record entries to reduce the management and maintenance costs of the record entries.

In some embodiments, with the knowledge and authorization of the target object 150 the recording module 310 may further reflect the record entry to generate interaction mode information associated with the target object 150. Such interaction mode information may indicate an interaction characteristic corresponding to the at least one historical interaction event.

As an example, the recording module 310 may extract a commonality feature based on the plurality of record entries to reflect the interaction characteristic associated with the target object 150. For example, the recording module 310 may extract, based on a plurality of historical record entries corresponding to the composing of a weekly report by the target object 310, a corresponding interaction characteristic as “compose a weekly report on Monday afternoon each week”, or “view a conference record before composing the weekly report”, and the like.

In some embodiments, the recording module 310 may utilize a specific processing model to implement the refining of the interaction mode information. Specifically, the recording module 310 may, for example, provide the plurality of record entries to be refined to the processing model to obtain one or more pieces of interaction mode information corresponding to the plurality of record entries to be refined. Such a processing model may be implemented with an appropriate machine learning model.

In some examples, the processing model may be the target processing entity 140 discussed with reference to FIG. 1. That is, the recording module 310 may obtain the refined interaction mode information by providing the target processing entity 140 with a prompt and a plurality of record entries to be refined for instructing the target processing entity 140 to perform interaction characteristic refining.

Based on the above manner, the recording module 310 may, for example, maintain one or more of: a record entry corresponding to the historical interaction event, a record compression entry obtained through the compression record entry, and/or interaction mode information obtained by refining the record entry, to be used for generation of the second information.

In some embodiments, the server 120 may utilize the target processing entity 140 to generate the second information, as discussed with reference to FIG. 1.

Specifically, the server 120 may process the first information based on the historical interaction information 130 to generate the third information. Further, the server 120 may provide the third information to the target processing entity 140, wherein the target processing entity 140 is different from the digital assistant 102. Additionally, the server 120 may generate the second information based on the processing result of the target processing entity 140 for the third information.

In some embodiments, the target processing entity 140 may include a target model, for example, a target language model. Accordingly, the third information may include, for example, input information for the target model. In some scenarios, such third information may also be referred to as a notification word, a prompt word, or a prompt, etc., to the target model. It should be understood that, depending on the needs of actual scenarios, the target processing entity 140 may, for example, also include other suitable model.

To obtain more accurate and effective third information, the server 120 may process the first information based on a set of record entries included in the historical interaction information 130. In some embodiments, after the digital assistant 102 receives the first information (also referred to as query/request information) input by the target object 150, the server 130 may determine, from the set of record entries maintained by the recording module 310, at least one record entry associated with the first information.

It should be understood that any suitable technique may be utilized to determine at least one record entry associated with the first information. For example, the server 120 may determine, based on the semantic analysis of the first information, at least one record entry associated with the semantics of the first information from the set of record entries. Alternatively, the server 120 may also determine, from the record library, at least one record entry associated with the semantics of the first information, for example, based on a search or a match of the keyword.

As an example, the server 120 may determine at least one associated record entry based on a similarity between the record entry and the first information, for example. Specifically, the server 120 may determine a set of description vectors corresponding to a set of record entries maintained in the record library and a target description vector corresponding to the received first information. Further, the server 120 may determine, from the set of record entries, at least one record entry associated with the first information based on the target description vector and the set of description vectors corresponding to the set of record entries.

As an example, the server 120 may, for example, determine, from the set of record entries, a record entry whose angle between the corresponding description vector and the target description entry vector is less than a threshold, as the at least one record entry associated with the first information.

For example, the first information input at the target object is “please refer to the style of my last weekly report to compose the weekly report of the week”. Accordingly, the record entry determined by the server 120 may include one or more record entries associated with the service object “last weekly report”.

Accordingly, the server 120 may further generate third information to be provided to the target processing entity 140 based on the first information and the associated at least one record entry. For example, the server 120 may add additional information corresponding to the associated at least one record entry on the basis of reserving the first information to generate the third information. As an example, such additional information may be generated, for example, based on the associated at least one record entry.

As another example, the server 120 may further rewrite the first information based on the associated at least one record entry, for example, expand the first information, so that the first information can more accurately reflect the requirement of the target object 150.

In some embodiments, the server 120 may also process the first information based on a set of record compression entries included in the historical interaction information 130 to generate second information. As an example, similar to the process of determining the associated record entry, the server 120 may determine at least one record compression entry associated with the first information from the set of record compression entries maintained by the record module 310.

Further, the server 120 may generate the third information to be provided to the target processing entity 140 by utilizing the determined at least one record compression entry and the first information. For example, the server 120 may add additional information corresponding to at least one associated record compression entry on the basis of reserving the first information to generate the third information. As an example, such additional information may be generated, for example, based on at least one associated record compression entry.

As another example, the server 120 may further rewrite the first information based on at least one associated record compression entry, for example, expanding the first information, so that the first information can more accurately reflect the requirement of the target object 150.

In some embodiments, the server 120 may further process the first information based on the interaction mode information included in the historical interaction information 130 to generate the second information. For example, the server 120 may determine, for example, at least one piece of interaction mode information associated with the first information.

Further, the server 120 may generate the third information to be provided to the target processing entity 140 by utilizing the determined at least one interaction mode information and the first information. For example, the server 120 may add additional information corresponding to the at least one associated interaction mode information on the basis of reserving the first information to generate the third information. As an example, such additional information may be generated, for example, based on the associated at least one interaction mode information.

As another example, the server 120 may further rewrite the first information based on the associated at least one interaction mode information, for example, expand the first information, so that the first information can more accurately reflect the requirement of the target object 150.

Based on this manner, the embodiments of the present disclosure can generate third information that is more consistent with the interaction requirement of the target object 150 based on the historical interaction information 130, and can improve the accuracy of information processing in the scenario where the user maintains his or her personal interaction habit.

Further, the terminal device 110 may further obtain second information generated based on the first information, and provide the second information to the target object 150 as a response to the first information.

The example process of generating the second information by the digital assistant 102 based on the first information input by the target object 150 is discussed above. Based on the above approach, the embodiments of the present disclosure can improve the accuracy of information processing, so that the generated second information is more in line with the interaction habits of the target object 150 and its requirement on the interaction result.

In addition, in this manner, embodiments of the present disclosure can also support a user with richer types of request. For example, the target object 150 may input the first information “Please refer to my last weekly report to compose the weekly report of the X project” to the digital assistant 102. Accordingly, the digital assistance 102 may generate the draft of the weekly report of the week based on historical interaction information corresponding the historical interaction event associated with composing the last weekly report in the document component by the target object 150. In this way, the embodiments of the present disclosure can further improve the content generation quality of the digital assistant, and improve the working efficiency of the user, and meet the user's needs.

As still another example, the target object 150 may input the first information “Please compose the weekly report of the X report” to the digital assistant 102, and accordingly, the digital assistant 102 may attach the access link of the conference record or the summary of the associated conference in the weekly report draft according to the interaction mode information determined in the historical interaction information (for example, the conference record is viewed before composing the weekly report). In this way, the embodiments of the present disclosure can help improve the information processing efficiency of the target object.

### Second Example Information Processing Procedure

FIG. 4 shows a flowchart of a process 400 for processing information according to some embodiments of the present disclosure. Process 400 may be implemented by a suitable electronic device or combination of electronic devices (e.g., server 120, terminal device 110, or a combination of server 120 and terminal device 110 in FIG. 1). For ease of description, the process 400 is described below by using the server 120 as an example and referring to FIG. 1.

As shown, in block 410, determine a set of historical interaction information between a target object and at least one service component.

For the process of the set of the historical interaction information, refer to the processes described above with reference to FIG. 2 and FIG. 3. For example, a corresponding set of record entries may be generated based on a set of historical interaction event between the target object and the at least one service component, to form a record library, that is, a set of historical interaction information.

At block 420, obtain configuration information indicating a part of the set of historical interaction information that is not provided to a digital assistant for interaction with the target object.

An example obtaining process of configuration information will be described below with reference to FIG. 5A to FIG. 5C. FIG. 5A to FIG. 5C illustrate example interface 500A to interface 500C, in accordance with some embodiments of the present disclosure. The interface 500A to the interface 500C may be provided by the terminal device 110, for example.

As shown in FIG. 5A, the interface 500A may be a viewing interface of a digital assistant, for example, may provide information such as an image identifier (for example, an avatar) and a text identifier (for example, a nickname) of the digital assistant, for example, when the digital assistant is a contact corresponding to the target, the interface 500A may be a personal homepage (profile page) of the digital assistant. Further, the interface 500A may also provide a setting portal 510, for example.

Upon receiving the selection of setting portal 510, terminal device 110 may present interface 500B as shown in FIG. 5B. As shown in FIG. 5B, in the interface 500B, the terminal device 110 may provide a portal for modifying the image identifier and the text identifier of the digital assistant 102.

Additionally, the terminal device 110 may also provide a control 515, for example, to receive a setting of whether the target object 150 has access to the specific type of data with respect to the digital assistant 102. Taking FIG. 5B as an example, the selected state of the control 515 may indicate that the target object 150 authorizes the digital assistant to access the document data.

In addition, in the interface 500B, the terminal device 110 may also provide a configuration portal 520 of the historical access. After receiving the selection of the configuration portal 520, the terminal device 110 may present a configuration interface 500C as shown in FIG. 5C.

As shown in FIG. 5C, the configuration interface 500C may present at least one set of configuration items, such as a first set of configuration items 530 and a second set of configuration items 540. In some embodiments, the first set of configuration items 530 and the second set of configuration items 540 may correspond to different service components, for example, the first set of configuration items 530 may correspond to a document component, and the second set of configuration items may correspond to a conference component, and may further have configuration items corresponding to a chat component, a mail component, a calendar component, and the like, and details are not described herein again.

Further, the terminal device 110 and/or the server 120 may receive a selection of the target object 150 for the target configuration item in the first set of configuration items 530 and/or the second set of configuration items 540. For example, the target object 150 may select the configuration item “to be deleted after 1 month” in the first set of configuration items 530, and select the configuration item “to be deleted after 3 months” in the second set of configuration item 530.

Further, the server 120 may determine the part of the set of historical interaction information that is not provided to the digital assistant 102 based on the selected target configuration item, so that the digital assistant 102 no longer considers the part when interacting with the target object 150.

Taking the first set of configuration items 530 as an example, in a scenario where the target object 150 selects “to be deleted after 1 month”, when generating a response to the target object 150, the digital assistant 102 will no longer consider “the historical interaction with the document component 1 month earlier”.

In some embodiments, as shown in FIG. 5C, the first set of data items 530 may correspond to different time ranges, for example. For example, the configuration item “to be deleted after 1 month” may correspond to the time range “one month earlier”; the configuration item “to be deleted after 3 months” may correspond to another time range “three months earlier”.

Further, in a scenario where the configuration item “delete after 1 month” is selected, part of the historical interaction information corresponding to the selected time range will not be provided to the digital assistant 102 for interaction with the target object 150. The generation and management of the historical interaction information may refer to the content described above with respect to FIG. 2 and FIG. 3, and details are not described herein again.

As an example, the recording module 310 may, for example, delete the record entry matching the configuration information from the record library according to the configuration information. For example, the recording module 310 may delete the record entry corresponding to the “document component” with the time element corresponding to “1 month earlier”. Additionally, the recording module 310 may also delete record compression entries and/or interaction mode information generated based on the interaction events of “1 month earlier”.

In this way, the embodiments of the present disclosure can enable the target object to customize the data range allowed to be accessed by the digital assistant, thereby improving the accuracy and reliability of processing information of the digital assistant.

With continued reference to FIG. 4, at block 430, determine, based on the configuration information, target historical interaction information from the set of historical interaction information for use by the digital assistant in generating a response to first information input to the digital assistant by the target object.

Specifically, target historical interaction information in the set of historical interaction information configured to be allowed to be provided to the digital assistance 102 may be obtained, and interaction between the digital assistant 102 and the target object 150 may be supported based on the target historical interaction information. For the process of generating the reply information based on the historical interaction information, refer to the content described above with respect to FIG. 2 and FIG. 3, and details are not described herein again.

In this way, embodiments of the present disclosure can enable the target object to configure a range of historical information that can be accessed by the digital assistant. In addition, by configuring the time range ignored by the digital assistant, embodiments of the present disclosure can provide a processing mechanism similar to “forgetting”, so that the result of information processing of the digital assistant is more in line with the user's expectation.

### Example Apparatus and Apparatus

FIG. 6 is a schematic structural block diagram of an apparatus 600 for processing information according to some embodiments of the present disclosure. The apparatus 600 may be implemented as or included in the server 120, the terminal device 110, or a combination of the server 120 and the terminal device 110 of FIG. 1. The various modules/components in the apparatus 600 may be implemented by hardware, software, firmware, or any combination thereof.

As shown, the apparatus 600 includes a first obtaining module 610, configured to obtain first information input by a target object to a digital assistant; and an information generation module 620, configured to generate second information as a response of the digital assistant to the first information based at least on the first information and historical interaction information between the target object and at least one service component.

In some embodiments, the information generation module 620 is further configured to: process the first information based on the historical interaction information to generate third information; provide the third information to a target processing entity; and generate the second information based on a processing result of the third information by the target processing entity.

In some embodiments, the third information comprises guidance information, and the target processing entity comprises a target model.

In some embodiments, the historical interaction information comprises a record library, the record library comprises a set of record entries, and the set of record entries is generated based on a set of historical interaction events between the target object and the at least one service component.

In some embodiments, a record entry comprises a knowledge element, and the knowledge element describes a service object corresponding to a respective historical interaction event.

In some embodiments, the record entry further comprises at least one of: a time element, configured to indicate an occurrence time of the respective historical interaction event, an action element, configured to indicate an event type of the respective historical interaction event, and a load element, configured to index the service object corresponding to the respective historical interaction event.

In some embodiments, the information generation module 620 is further configured to: determine at least one record entry associated with the first information from the set of record entries; and generate the second information based on the first information and the at least one record entry.

In some embodiments, the information generation module 620 is further configured to: determine a set of description vectors corresponding to the set of record entries and a target description vector corresponding to the first information; and determine the at least one record entry associated with the first information from the set of record entries based on the target description vector and the set of description vectors.

In some embodiments, an angle between at least one description vector corresponding to the at least one record entry and the target description vector is less than a threshold.

In some embodiments, the information generation module 620 is further configured to: determine at least one record compression entry associated with the first information from a set of record compression entries, wherein each record compression entry is generated based on a plurality of record entries; and generate the second information based on the first information and the at least one record compression entry.

In some embodiments, the apparatus 600 further comprises a compression module configured to: in response to a plurality of historical interaction events satisfying a predetermined condition, remove a plurality of record entries corresponding to the plurality of historical interaction events from the record library; and generate a corresponding record compression entry based on the plurality of record entries.

In some embodiments, the predetermined condition comprises: the plurality of historical interaction events have occurred for more than a threshold duration.

In some embodiments, the compression module is further configured to: provide the plurality of record entries to a compression model to obtain a record compression entry corresponding to the plurality of record entries.

In some embodiments, the information generation module 620 is further configured to: determine interaction mode information associated with the target object, the interaction mode information indicating an interaction characteristic corresponding to at least one historical interaction event; and generate the second information based on the first information and the interaction mode information.

In some embodiments, the historical interaction information is target historical interaction information, and the apparatus 600 further comprises a configuration module configured to: determining, based on configuration information associated with the target object, the target historical interaction information from a set of historical interaction information between the target object and the at least one service component, wherein the configuration information indicates a part of the set of historical interaction information that is not provided to the digital assistant for interaction with the target object.

FIG. 7 is a schematic structural block diagram of an apparatus 700 for processing information according to some embodiments of the present disclosure. The apparatus 700 may be implemented as or included in the server 120, the terminal device 110, or a combination of the server 120 and the terminal device 110 of FIG. 1. The various modules/components in the apparatus 700 may be implemented by hardware, software, firmware, or any combination thereof.

As shown, the apparatus 700 comprises a history determination module 710, configured to determine a set of historical interaction information between a target object and at least one service component; a second obtaining module 720, configured to obtain configuration information indicating a part of the set of historical interaction information that is not provided to a digital assistant for interaction with the target object; and an information determination module 730, configured to determine, based on the configuration information, target historical interaction information from the set of historical interaction information for use by the digital assistant in generating a response to first information input to the digital assistant by the target object.

In some embodiments, the second obtaining module 710 is further configured to: provide a configuration interface for the digital assistant, the configuration interface presenting at least one set of configuration items; receive a selection by the target object for a target configuration item in the at least one set of configuration items; and determine the configuration information corresponding to the selected target configuration item.

In some embodiments, the at least one set of configuration items comprises a plurality of sets of configuration items corresponding to a plurality of service components.

In some embodiments, different configuration items in each set of configuration items correspond to different time ranges, and each configuration item indicates that a part of historical interaction information corresponding to a respective time range is not provided to the digital assistant for interaction with the target object.

In some embodiments, the set of historical interaction information comprises a record library, the record library comprises a set of record entries, and the set of record entries is generated based on a set of historical interaction events between the target object and the at least one service component.

In some embodiments, the apparatus 700 further comprises a removing module configured to, in response to a particular record entry in the record library matching the configuration information, remove the particular record entry from the record library.

FIG. 8 shows a block diagram illustrating an electronic device 800 in which one or more embodiments of the present disclosure may be implemented. It should be understood that the electronic device 800 illustrated in FIG. 8 is merely exemplary and should not constitute any limitation on the functionality and scope of the embodiments described herein. The electronic device 800 shown in FIG. 8 may be configured to implement the server 80, the terminal device 110 and a combination of the server 80 and the terminal device 110 in FIG. 1.

As shown in FIG. 8, the electronic device 800 is in the form of a general-purpose electronic device. Components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor and capable of performing various processes according to programs stored in the memory 820. In multiprocessor system, multiple processing units execute computer-executable instructions in parallel to improve parallel processing capabilities of electronic device 800.

Electronic device 800 typically includes a plurality of computer storage media. Such media may be any available media accessible to the electronic device 800, including, but not limited to, volatile and non-volatile media, removable and non-removable media. The memory 820 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 830 may be a removable or non-removable medium and may include a machine-readable medium, such as a flash drive, magnetic disk, or any other medium, which may be capable of storing information and/or data and may be accessed within electronic device 800.

The electronic device 800 may further include additional removable/non-removable, volatile/non-volatile storage media. Although not shown in FIG. 8, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interface. The memory 820 may include a computer program product 825 having one or more program modules configured to perform various methods or actions of various embodiments of the present disclosure.

The communication unit 840 is configured to communicate with another electronic device through a communication medium. Additionally, the functionality of components of the electronic device 800 may be implemented in a single computing cluster or multiple computing machines capable of communicating over a communication connection. Thus, the electronic device 800 may operate in a networked environment using logical connections with one or more other servers, network personal computers (PCs), or another network Node.

The input device 850 may be one or more input devices, such as a mouse, a keyboard, a trackball, or the like. The output device 860 may be one or more output devices, such as a display, a speaker, a printer, or the like. The electronic device 800 may also communicate with one or more external devices (not shown) through the communication unit 840 as needed, external devices such as storage devices, display devices, etc., communicate with one or more devices that enable a user to interact with the electronic device 800, or communicate with any device (e.g., a network card, a modem, etc.) that enables the electronic device 800 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Various aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/actions specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/actions specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. A method of processing information, comprising:
obtaining first information input by a target object to a digital assistant; and
generating second information as a response of the digital assistant to the first information based at least on the first information and historical interaction information between the target object and at least one service component.

2. The method of claim 1, wherein the generating second information based at least on the first information and historical interaction information between the target object and at least one service component comprises:
processing the first information based on the historical interaction information to generate third information;
providing the third information to a target processing entity; and
generating the second information based on a processing result of the third information by the target processing entity.

3. The method of claim 2, wherein the third information comprises guidance information, and the target processing entity comprises a target model.

4. The method of claim 1, wherein the historical interaction information comprises a record library, the record library comprises a set of record entries, and the set of record entries is generated based on a set of historical interaction events between the target object and the at least one service component.

5. The method of claim 4, wherein a record entry comprises a knowledge element, and the knowledge element describes a service object corresponding to a respective historical interaction event.

6. The method of claim 5, wherein the record entry further comprises at least one of:
a time element, configured to indicate an occurrence time of the respective historical interaction event,
an action element, configured to indicate an event type of the respective historical interaction event,
a load element, configured to index the service object corresponding to the respective historical interaction event.

7. The method of claim 4, wherein the generating second information based at least on the first information and historical interaction information between the target object and at least one service component comprises:
determining at least one record entry associated with the first information from the set of record entries; and
generating the second information based on the first information and the at least one record entry.

8. The method of claim 7, wherein determining at least one record entry associated with the first information from the set of record entries comprises:
determining a set of description vectors corresponding to the set of record entries and a target description vector corresponding to the first information; and
determining the at least one record entry associated with the first information from the set of record entries based on the target description vector and the set of description vectors.

9. The method of claim 4, wherein generating the second information based on the first information and the at least one record entry comprises:
determining at least one record compression entry associated with the first information from a set of record compression entries, wherein each record compression entry is generated based on a plurality of record entries; and
generating the second information based on the first information and the at least one record compression entry.

10. The method of claim 9, further comprising:
in response to a plurality of historical interaction events satisfying a predetermined condition, removing a plurality of record entries corresponding to the plurality of historical interaction events from the record library; and
generating a corresponding record compression entry based on the plurality of record entries.

11. The method of claim 10, wherein the predetermined condition comprises: the plurality of historical interaction events have occurred for more than a threshold duration.

12. The method of claim 10, wherein generating a corresponding record compression entry based on the plurality of record entries comprises:
providing the plurality of record entries to a compression model to obtain a record compression entry corresponding to the plurality of record entries.

13. The method of claim 4, wherein generating the second information based on the first information and the at least one record entry comprises:
determining interaction mode information associated with the target object, the interaction mode information indicating an interaction characteristic corresponding to at least one historical interaction event; and
generating the second information based on the first information and the interaction mode information.

14. The method of claim 1, wherein the historical interaction information is target historical interaction information, and the method further comprises:
determining, based on configuration information associated with the target object, the target historical interaction information from a set of historical interaction information between the target object and the at least one service component,
wherein the configuration information indicates a part of the set of historical interaction information that is not provided to the digital assistant for interaction with the target object.

15. A method of processing information, comprising:
determining a set of historical interaction information between a target object and at least one service component;
obtaining configuration information indicating a part of the set of historical interaction information that is not provided to a digital assistant for interaction with the target object; and
determining, based on the configuration information, target historical interaction information from the set of historical interaction information for use by the digital assistant in generating a response to first information input to the digital assistant by the target object.

16. The method of claim 15, wherein obtaining configuration information comprises:
providing a configuration interface for the digital assistant, the configuration interface presenting at least one set of configuration items;
receiving a selection by the target object for a target configuration item in the at least one set of configuration items; and
determining the configuration information corresponding to the selected target configuration item.

17. The method of claim 16, wherein different configuration items in each set of configuration items correspond to different time ranges, and each configuration item indicates that a part of historical interaction information corresponding to a respective time range is not provided to the digital assistant for interaction with the target object.

18. The method of claim 15, wherein the set of historical interaction information comprises a record library, the record library comprises a set of record entries, and the set of record entries is generated based on a set of historical interaction events between the target object and the at least one service component.

19. The method of claim 18, further comprising:
in response to a particular record entry in the record library matching the configuration information, removing the particular record entry from the record library.

20. An electronic device, comprising:
at least one processing unit; and
at least one memory coupled to the at least one processing unit and storing instructions for execution by the at least one processing unit, the instructions, when executed by the at least one processing unit, causing the electronic device to perform at least;
obtaining first information input by a target object to a digital assistant; and
generating second information as a response of the digital assistant to the first information based at least on the first information and historical interaction information between the target object and at least one service component.
